(19) United States
(12) Patent Application Publication
(10) Pub. No.: US 2025/0124545 A1
(43) Pub. Date: Apr. 17, 2025

(54) ELECTRONIC DEVICE

(71) Applicant: CANON KABUSHIKI KAISHA, Tokyo (JP)

(72) Inventor: SHINICHI HAGIWARA, Tokyo (JP)

(21) Appl. No.: 18/897,650

(22) Filed: Sep. 26, 2024

(30) Foreign Application Priority Data
Oct. 13, 2023 (JP) 2023-177479

(51) Int. Cl. G06T 3/4084; G06T 5/80; H04N 13/344

(52) U.S. Cl. CPC G06T 3/4084; G06T 5/80; H04N 13/344

(57) ABSTRACT

An electronic device according to the present invention includes a processor, and a memory storing a program which, when executed by the processor, causes the electronic device to perform setting processing of setting a display magnification of an image, perform image processing to reduce distortion of the image, and perform control processing of performing control to display a processed image at the display magnification set by the setting processing, the processed image being an image after the image processing is performed, wherein, in the control processing, in a case where a first display magnification is set, control is performed to perform stereoscopically viewable display as display of the processed image, and, in a case where a second display magnification different from the first display magnification is set, control is performed to perform stereoscopically unviewable display as the display of the processed image.

### BACKGROUND OF THE INVENTION

### Field of the Invention

The present invention relates to an electronic device, and more particularly, to a technique for displaying an image at a set display magnification.

### Description of the Related Art

A digital camera having two optical systems is known (JP 2013-141052 A). If the two optical systems are arranged so as to capture images in the same direction, two images with parallax can be obtained with the two optical systems, and, from the obtained two images, an image in a range of 180 degrees (a half-spherical image) can be generated, or an image that allows stereoscopic viewing can be generated. If the two optical systems are arranged so as to capture images in diametrically opposite directions, an image in a range of 360 degrees (a whole spherical image) can be generated from the two images acquired with the two optical systems.

In a case where an image (two images having parallax) is to be displayed in a stereoscopically viewable manner, if the display magnification is changed (if the image is enlarged or reduced), the parallax between the two images also changes, and the user might not be able to suitably perform stereoscopic viewing. For example, if the parallax becomes too large due to an increase in the display magnification, the user cannot recognize the same object in the two images as one object, and perceives a double image. The user might feel uncomfortable due to the perception of the double image.

JP 2003-107601 A discloses a stereoscopic imaging device that changes the baseline length and the angle of convergence between the right and left imaging optical systems of the stereoscopic imaging device, on the basis of zoom magnification information.

However, even if the baseline length and the angle of convergence between the imaging optical systems are changed, the parallax between captured (recorded) images (two images) does not change. Therefore, even if the technique disclosed in JP 2003-107601 A is used, when the display magnification is changed during reproduction of a captured (recorded) image, the parallax of the image changes, and the user might not be able to suitably perform stereoscopic viewing.

### SUMMARY OF THE INVENTION

The present invention provides a technique for enabling suitable display even in a case where the display magnification is changed during reproduction of a captured (recorded) image.

An electronic device according to the present invention includes a processor, and a memory storing a program which, when executed by the processor, causes the electronic device to perform setting processing of setting a display magnification of an image, perform image processing to reduce distortion of the image, and perform control processing of performing control to display a processed image at the display magnification set by the setting processing, the processed image being an image after the image processing is performed, wherein, in the control processing, in a case where a first display magnification is set, control is performed to perform stereoscopically viewable display as display of the processed image, and, in a case where a second display magnification different from the first display magnification is set, control is performed to perform stereoscopically unviewable display as the display of the processed image.

Further features of the present invention will become apparent from the following description of exemplary embodiments with reference to the attached drawings.

### BRIEF DESCRIPTION OF THE DRAWINGS

FIG. 1 is a schematic diagram illustrating an image according to a first embodiment;

FIG. 2 is an external diagram illustrating a lens unit according to the first embodiment;

FIG. 3 is a block diagram illustrating the lens unit according to the first embodiment;

FIG. 4 is a block diagram illustrating an HMD according to the first embodiment;

FIG. 5 is a flowchart illustrating an operation of the HMD according to the first embodiment;

FIG. 6 is a flowchart illustrating an operation of an HMD according to a second embodiment;

FIGS. 7A to 7C are schematic diagrams illustrating images according to the first embodiment; and

FIG. 8 is a schematic diagram illustrating perspective projection transformation according to the first embodiment.

### DESCRIPTION OF THE EMBODIMENTS

In the description below, embodiments of the present invention will be explained, with reference to the accompanying drawings.

### First Embodiment

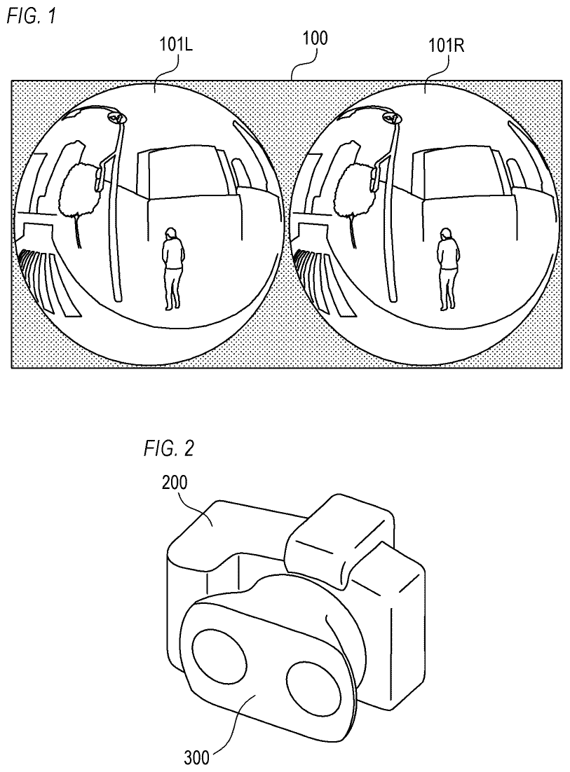

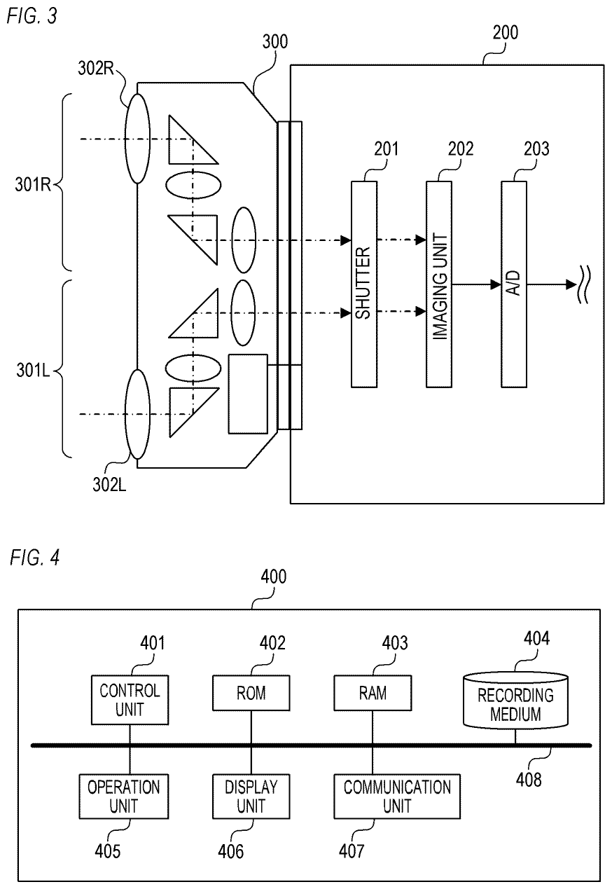

A first embodiment of the present invention is now described. FIG. 1 is a schematic diagram illustrating an image 100 according to the first embodiment. FIGS. 2 and 3 are schematic diagrams illustrating a lens unit 300 according to the first embodiment. FIG. 2 is an external view, and FIG. 3 is a block diagram. The lens unit 300 is a kind of interchangeable lens unit (interchangeable lens) attachable to and detachable from a camera 200, and FIGS. 2 and 3 illustrate a state in which the lens unit 300 is attached to the camera 200. The image 100 is an image captured with the lens unit 300, for example. The lens unit 300 has two optical systems 301L and 301R that face in the same direction, and, with the lens unit 300, it is possible to acquire one image 100 including two image areas 101L and 101R having parallax. By dividing the image 100 into an image for the left eye and an image for the right eye and displaying the images in VR display, the user can view a stereoscopic VR image in a substantially 180-degree range, for example.

The lens unit 300 is a dual-lens unit (VR180 lens unit) for obtaining a VR180 image that is one of virtual reality (VR) image formats that enable dual-lens stereoscopic viewing. In the first embodiment, the lens unit 300 has a fish-eye lens in each of the optical systems 301L and 301R, the fish-eye lens being capable of capturing the range of about 180 degrees. Note that the range that can be captured by the lens of each of the optical systems 301L and 301R may be a range of about 160 degrees, which is narrower than the range of 180 degrees. The lens unit 300 can form a left image formed through the optical system 301L and a right image formed through the optical system 301R on one or two imaging elements of the camera to which the lens unit 300 is attached. In the camera 200, the left image and the right image are formed on one imaging unit 202 (an imaging element; an image sensor) via a shutter 201, and one image (dual-lens image) in which a left image area (the area of the left image) and a right image area (the area of the right image) are arranged side by side is generated. An analog signal corresponding to the formed image (optical image) is output from the imaging unit 202, and the analog signal is converted into digital data by an A/D converter 203. An image captured by the camera 200 with the lens unit 300 is a kind of VR image.

Here, a VR image is an image that can be viewed in VR display described below. Examples of VR images include an omnidirectional image (whole spherical image) captured by an omnidirectional camera (whole spherical camera) and a panoramic image having a wider video range (effective video range) than a display range that can be displayed at once on a display unit. Examples of VR images also include a moving image and a live image (an image acquired substantially in real time from a camera), as well as a still image. The VR image has a maximum video range (effective video range) corresponding to a field of view of 360 degrees in a left-to-right direction and 360 degrees in an up-and-down direction. Examples of VR images also include images having a larger angle of view than an angle of view that can be captured by a typical camera or a wider video range than a display range that can be displayed at once on the display unit, even when the angle of view or video range is smaller than 360 degrees in the left-to-right direction and 360 degrees in the up-and-down direction. An image captured by the camera 200 with the lens unit 300 described above is a kind of VR image.

FIG. 4 is a block diagram illustrating the configuration of a head-mounted display (HMD) 400 as an example of an electronic device according to the first embodiment. The user wears the HMD 400 on the head, and visually recognizes an image displayed by the HMD 400.

A control unit 401 is a central processing unit (CPU) that controls the entire HMD 400, for example. A read only memory (ROM) 402 stores programs and parameters in a non-transitory manner. A random access memory (RAM) 403 temporarily stores programs and data that are supplied from an external device and the like. A recording medium 404 is a hard disk, a flash memory, or the like secured in the HMD 400. Alternatively, the recording medium 404 is an optical disk, a magnetic card, an optical card, an IC card, a memory card, or the like that is attachable to and detachable from the HMD 400. An operation unit 405 receives a user operation performed on the HMD 400. The operation unit 405 may be buttons, a touch panel, or the like provided on the HMD 400, or may be a keyboard, a mouse, or the like that is attachable to and detachable from the HMD 400. A display unit 406 displays information (an image) held by the HMD 400, information supplied from an external device, or the like, under the control of the control unit 401. A communication unit 407 communicates with an external device such as another camera. A system bus 408 communicatively connects a plurality of components of the HMD 400 to one another.

The HMD 400 can perform VR display of a VR image by setting the display mode to “VR view”. A VR image having a 360-degree angle of view is displayed in VR display, and the user changes the orientation of the HMD 400 (the head) in the left-to-right direction (horizontal rotation direction), so that an omnidirectional video image that is seamless in the left-to-right direction can be viewed.

The VR display (VR view) is a display method (display mode) for displaying, from among VR images, a video image in a field-of-view range depending on the orientation of the display device, the display method being capable of changing its display range. Examples of the VR display include “single-lens VR display (single-lens VR view)” in which an image is displayed after deformation (distortion correction) for mapping a VR image on a virtual sphere. Examples of the VR display includes “dual-lens VR display (dual-lens VR view)” in which a left-eye VR image and a right-eye VR image are displayed in left and right areas side by side after deformation for mapping the VR images on a virtual sphere. The “dual-lens VR display” is performed by using a left-eye VR image and a right-eye VR image having parallax, to enable stereoscopic viewing of the VR images. In any type of VR display, in a case where the user wears an HMD, for example, a video image is displayed in a field-of-view range corresponding to the orientation of the user's face. For example, it is assumed that from among the VR images, a video image is displayed in a field-of-view range having the center thereof at 0 degrees in the left-to-right direction (a specific orientation, such as the north) and 90 degrees in the up-and-down direction (90 degrees from the zenith, which is the horizon) at one point of time. In this state, if the orientation of the display device is reversed (for example, the display surface is changed from a southern direction to a northern direction), from among the same VR images, the display range is changed to a video image in a field-of-view range having the center thereof at 180 degrees in the left-to-right direction (the opposite orientation, such as the south) and 90 degrees in the up-and-down direction. In other words, when the user wearing the HMD faces the south from the north (or looks back), the video image displayed on the HMD is changed from a video image of the north to a video image of the south. Note that the VR image captured with the lens unit 300 is an image (180-degree image) obtained by capturing the range of about 180 degrees in the front, and there are no video images in the range of about 180 degrees in the rear. In the VR display of such an image, when the orientation of the display device is changed to a side at which any video image does not exist, a blank area is displayed.

Such VR display of a VR image makes the user visually feel like existing in the VR image (in a VR space) (sense of immersion). Note that the VR image display method is not limited to the method for changing the orientation of the display device. For example, the display range may be moved (scrolled) in response to a user operation via a touch panel, directional buttons, or the like. In addition to the change of the display range by changing the orientation during the VR display (in the “VR view” display mode), the display range may be changed in response to a touch-move on the touch panel, a dragging operation with a mouse device or the like, or pressing the directional buttons. Note that a smartphone or a tablet terminal mounted to VR goggles (a head-mounted adapter) is a kind of HMD.

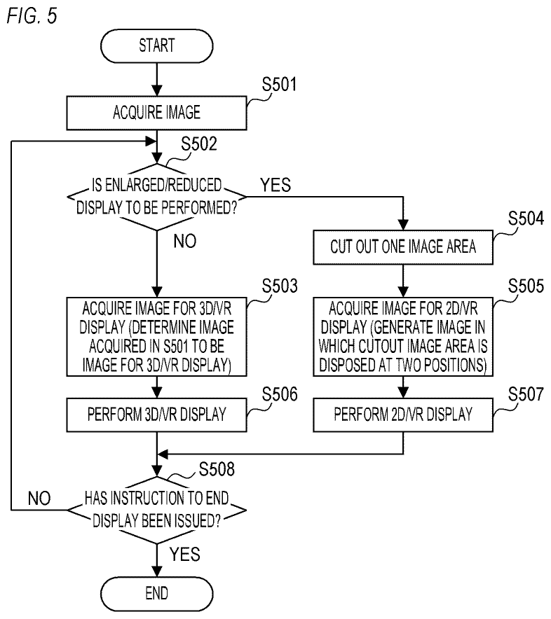

FIG. 5 is a flowchart showing an operation of the HMD 400. This operation is realized by the control unit 401 of the HMD 400 loading a program stored in the ROM 402 into the RAM 403, and executing the program. For example, when the user performs an operation to display an image on the HMD 400, the operation shown in FIG. 5 starts.

In step S501, the control unit 401 acquires an image to be displayed. In the first embodiment, it is assumed that the control unit 401 acquires an image captured by the camera 200 to which the lens unit 300 is attached. For example, an image captured by the camera 200 is recorded in the recording medium 404, and the control unit 401 acquires the image captured by the camera 200 from the recording medium 404. The control unit 401 may acquire the image captured by the camera 200, from the camera 200 via the communication unit 407. The control unit 401 may acquire a still image, a moving image, or a live image (an image acquired from a camera in substantially real time).

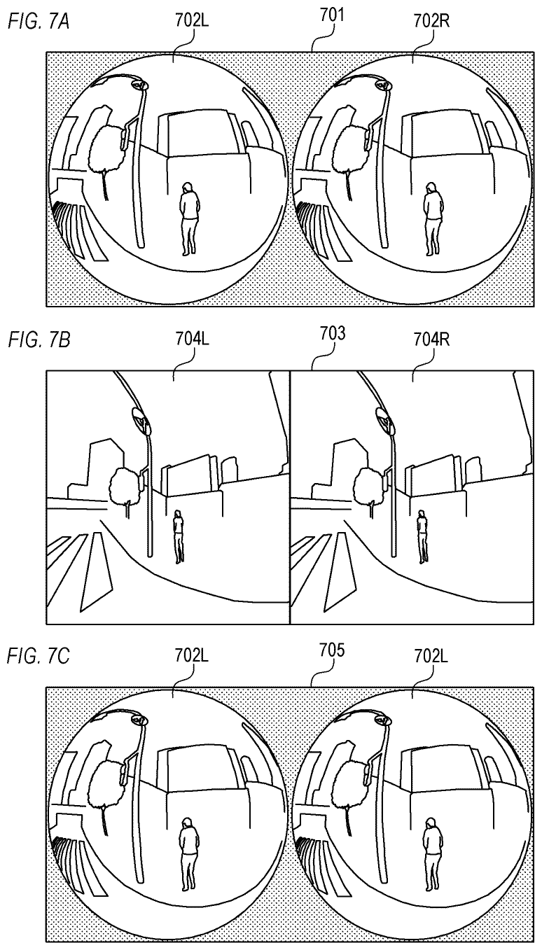

For example, in step S501, an image 701 illustrated in FIG. 7A is acquired. The image 701 is an image captured with the lens unit 300 (a dual-lens unit), and includes two (circumferential) fish-eye image areas 702L and 702R having parallax. The fish-eye image area 702L is an image captured via the optical system 301L, and the fish-eye image area 702R is an image captured via the optical system 301R. In each of the fish-eye image areas 702L and 702R, the closer to the outer edge of the circle, the larger the image (object) distortion.

In step S502, the control unit 401 determines whether to perform enlarged/reduced display. In the enlarged/reduced display, an image (or a display range) is enlarged or reduced at a different display magnification from a predetermined magnification. The user issues an instruction to change the display magnification, using a touch panel or buttons that are the operation unit 405, for example. When instructed to change the display magnification, the control unit 401 sets the display magnification in accordance with the instruction (changes the set display magnification). In the first embodiment, the predetermined display magnification is assumed to be the same magnification (100%), but the predetermined display magnification is not limited to the same magnification, and may be any magnification at which suitable stereoscopic viewing of the left and right image areas is possible. At the same magnification, for example, the object is displayed in a size corresponding to the appearance from the camera 200 when captured by the camera 200 to which the lens unit 300 is attached. In a case where enlarged/reduced display is not to be performed, or where display is performed at the same magnification, the process moves on to step S503. In a case where enlarged/reduced display is to be performed, the process moves on to step S504. Note that a range including a plurality of display magnifications at which suitable stereoscopic viewing is possible is determined in advance. In a case where display is performed at a display magnification within the range, the process may move on to step S503. In a case where display is performed at a display magnification outside the range, the process may move on to step S504.

In step S503, the control unit 401 acquires one image including both of the two image areas having parallax, to perform 3D/VR display (stereoscopically viewable VR display using the parallax between the left and right image areas). In the first embodiment, in step S501, the control unit 401 acquires one image including two image areas having parallax. In step S503, the control unit 401 then determines the image acquired in step S501 to be an image for 3D/VR display. Note that, in step S501, the control unit 401 may acquire an image captured with a single-lens unit. In step S503, the control unit 401 may then generate two images having parallax from the one image.

Note that, in step S503, the control unit 401 may perform image processing to reduce image distortion. For example, the control unit 401 may acquire an image in a VR180 format by applying equirectangular transformation to the two fish-eye image areas 702L and 702R as illustrated in FIG. 7A.

For example, an image 703 illustrated in FIG. 7B is acquired by performing equirectangular transformation. An image area 704L included in the image 703 is an image area obtained by applying equirectangular transformation to the fish-eye image area 702L in FIG. 7A. An image area 704R included in the image 703 is an image area obtained by applying equirectangular transformation to the fish-eye image area 702R in FIG. 7A. As can be seen from the fish-eye image areas 702L and 702R in FIG. 7A and the image areas 704L and 704R in FIG. 7B, image distortion is reduced by equirectangular transformation.

In steps S504 and S505, the control unit 401 acquires one image including two image areas having no parallax, to perform 2D/VR display (stereoscopically unviewable VR display). In step S504, the control unit 401 cuts out (extracts) one of the two image areas (fish-eye image areas) from the image acquired in step S501. In step S505, the control unit 401 generates one image in which the image area cut out in step S504 is disposed at two positions. Thus, it becomes possible to display the same image area on the display screens for the right eye and the left eye of the HMD 400. Note that the control unit 401 may apply image processing (equirectangular transformation, for example) for reducing image distortion to the image area cut out in step S504.

For example, in step S505, an image 705 illustrated in FIG. 7C is generated. In the image 705, the fish-eye image area 702L in FIG. 7A is disposed at two positions on the right and left sides. Note that, in step S505, an image in which the fish-eye image area 702R is disposed at two positions may be generated.

The control unit 401 then controls the display unit 406 to display the image in VR display at the set display magnification. At the time of VR display, the control unit 401 performs image processing to reduce image distortion. For example, the control unit 401 performs perspective projection transformation of a VR image.

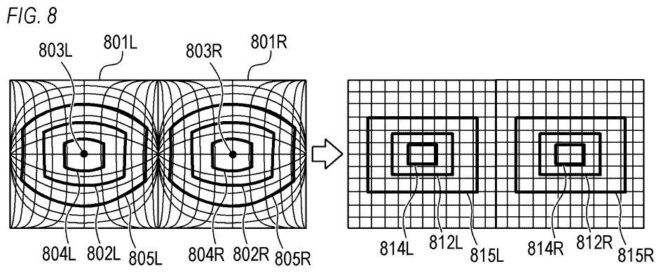

In a case where enlarged/reduced display is not to be performed, the control unit 401 in step S506 performs VR display of the image acquired in step S503. Here, a specific operation is described with reference to FIG. 8. Image areas 801L and 801R correspond to the two image areas 704L and 704R after the equirectangular transformation in FIG. 7B. The control unit 401 performs perspective projection transformation on predetermined ranges 802L and 802R corresponding to the orientation of the HMD 400 in the image areas 801L and 801R, to generate images 812L and 812R, and perform control to display the images 812L and 812R on the respective screens for the left eye and the right eye. The two image areas 801L and 801R for 3D/VR display have parallax with each other, and the images 812L and 812R after the perspective projection transformation also have parallax with each other. Thus, the viewer of the HMD 400 can stereoscopically view a VR image.

In a case where enlarged/reduced display is to be performed, the control unit 401 in step S507 performs VR display of the image acquired in step S505. Positions 803L and 803R are the central positions of the predetermined ranges 802L and 802R corresponding to the orientation of the HMD 400 in the image areas 801L and 801R. The control unit 401 performs perspective projection transformation of ranges 804L and 804R or ranges 805L and 805R corresponding to the set display magnification, with the positions 803L and 803R being the centers. By doing so, the control unit 401 generates images 814L and 814R or images 815L and 815R. The control unit 401 then performs control to display the images 814L and 814R or the images 815L and 815R on the respective screens for the right eye and the left eye. The images to be displayed are the images 814L and 814R in a case where enlarged images at a higher magnification than the same magnification are displayed. The images to be displayed are the images 815L and 815R in a case where reduced images at a lower magnification than the same magnification are displayed. Since the two image areas 801L and 801R for 2D/VR display are the same images, there is no parallax between them. Since there is no parallax between the images 814L and 814R or the images 815L and 815R after the perspective projection transformation, the viewer of the HMD 400 cannot stereoscopically view any VR image.

Note that, in the first embodiment, in a case where enlarged/reduced display is to be performed, the control unit 401 cuts out the entire image areas (fish-eye image areas) in step S504, and acquires an image in which the image areas are disposed at two positions without changing the size of the cutout image areas in step S505. In step S507, the control unit 401 then enlarges or reduces the two image areas included in the image acquired in step S505 at the set display magnification, and displays the enlarged or reduced image areas on the display unit 406. However, the process to be performed in the case of enlarged/reduced display is not limited to this. For example, in step S505, the control unit 401 may acquire an image for 2D/VR display by enlarging or reducing the cutout image areas at the set display magnification, and disposing the cutout image areas at two positions. In step S507, the control unit 401 may then display the two image areas included in the image acquired in step S505 on the display unit 406, without enlarging or reducing the image areas. In a case where enlarged display is performed, the control unit 401 may cut out part of the image areas (fish-eye image areas) in accordance with the set display magnification in step S504.

In step S508, the control unit 401 determines whether an instruction to end the VR display has been issued. The user issues an instruction to end the VR display, using the touch panel or the buttons that are the operation unit 405, for example. In a case where an instruction to end the VR display has been issued, the operation in FIG. 5 is ended. In a case where an instruction to end the VR display has not been issued, the process moves on to step S502.

As described above, according to the first embodiment, 3D display (stereoscopically viewable display) and 2D display (display in a planar view, or stereoscopically unviewable display) are switched in accordance with the display magnification. In this manner, suitable display can be performed even in a case where the display magnification is changed during reproduction of a captured (recorded) image. For example, 3D display can be performed in a case where suitable stereoscopic viewing is possible, and 2D display can be performed in a case where suitable stereoscopic viewing is not possible.

### Second Embodiment

A second embodiment of the present invention is now described. In the second embodiment, it is assumed that a specific mode in which enlarged/reduced display is not to be performed can be set. Note that, in the description below, explanation of the same aspects as those of the first embodiment (the same components and processes as those of the first embodiment, for example) will not be made.

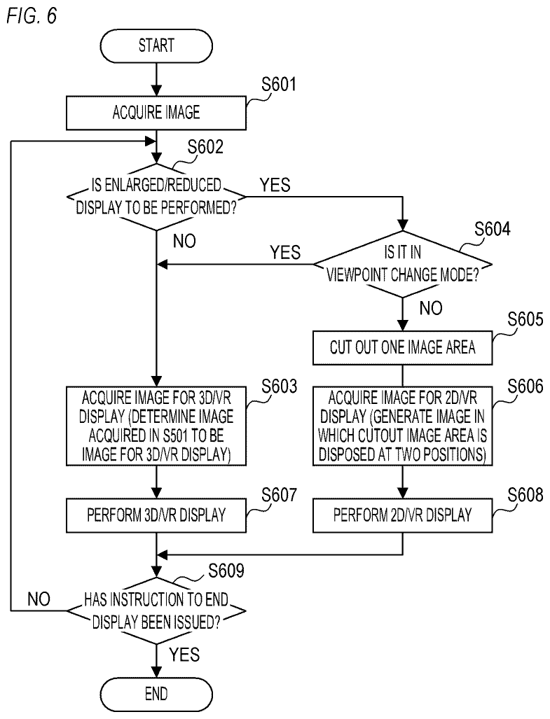

FIG. 6 is a flowchart illustrating an operation of an HMD 400 according to the second embodiment. This operation is realized by the control unit 401 of the HMD 400 loading a program stored in the ROM 402 into the RAM 403, and executing the program. For example, when the user performs an operation to display an image on the HMD 400, the operation shown in FIG. 6 starts.

Steps S601 and S602 are the same as steps S501 and S502 of the first embodiment (FIG. 5). In a case where enlarged/reduced display is not to be performed, the process moves from step S602 on to step S603. In a case where enlarged/reduced display is to be performed, the process moves from step S602 on to step S604. Step S603 is the same as step S503 of the first embodiment (FIG. 5).

In step S604, the control unit 401 determines whether the mode of the HMD 400 is a viewpoint change mode. The viewpoint change mode is used in a case where the display range is significantly moved. In a case where the position (viewpoint) of the display range is moved by the same amount of movement, a larger amount of movement is required as the amount of movement of the head of the user when the display magnification is higher. The user might then feel uncomfortable about the large movement of the head when the display magnification is high. Further, VR sickness might be caused due to a large difference between the amount of movement of the display range and the amount of movement of the head. Therefore, in a case where the mode of the HMD 400 is the viewpoint change mode, the display magnification is temporarily changed to the same magnification, and the process moves on to step S603. In a case where the mode of the HMD 400 is not the viewpoint change mode, the process moves on to step S605. Steps S605 to S609 are the same as steps S504 to S508 of the first embodiment (FIG. 5).

Note that the method for setting the viewpoint change mode is not limited to any particular method. For example, the user may select the viewpoint change mode, using the touch panel or the buttons that are the operation unit 405. The control unit 401 may then set the viewpoint change mode, in response to the selection of the viewpoint change mode by the user. Likewise, the control unit 401 may cancel the setting of the viewpoint change mode in accordance with a user operation.

The control unit 401 may set the viewpoint change mode and cancel the setting, using orientation information (an output signal from an acceleration sensor) about the HMD 400. For example, the control unit 401 may determine whether the amount of change in the orientation of the HMD 400 is larger than a threshold, set the viewpoint change mode in a case where the amount of change is larger than the threshold, and cancel the setting of the viewpoint change mode in a case where the amount of change is smaller than the threshold. The amount of change in the orientation of the HMD 400 may be interpreted as the amount of movement of the display range. In a case where the amount of movement of the display range is used, the threshold may be changed in accordance with the display magnification.

As described above, according to the second embodiment, 3D display (stereoscopically viewable display) and 2D display (stereoscopically unviewable display) are switched, depending on whether a specific mode is set (whether the amount of movement of the display range is larger than the threshold). Thus, suitable display can be performed in a larger number of scenes.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

Although an example in which the present invention is applied to a head-mounted display (HMD) device has been described, the present invention can also be applied to an electronic device of a pair different from an HMD, for example. An electronic device to which the present invention is applied may control display on an HMD connected to the electronic device. In that case, an image after the perspective projection transformation may be sent from the electronic device to the HMD, or an image before the perspective projection transformation (the image acquired in step S503 or step S505 in FIG. 5, for example) may be sent from the electronic device to the HMD, and the perspective projection transformation may be performed in the HMD.

Furthermore, the present invention may be applied to an HMD equipped with a camera, such as a video see-through HMD. The present invention can be applied not only in a case where an image in a real space is to be displayed, but also in a case an image in a virtual space formed by CG is to be displayed.

According to the present invention, suitable display can be performed even in a case where the display magnification is changed during reproduction of a captured (recorded) image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-177479, filed on Oct. 13, 2023, which is hereby incorporated by reference herein in its entirety.

What is claimed is:

1. An electronic device comprising:
a processor; and
a memory storing a program which, when executed by the processor, causes the electronic device to
perform setting processing of setting a display magnification of an image,
perform image processing to reduce distortion of the image, and
perform control processing of performing control to display a processed image at the display magnification set by the setting processing, the processed image being an image after the image processing is performed, wherein,
in the control processing, in a case where a first display magnification is set, control is performed to perform stereoscopically viewable display as display of the processed image, and, in a case where a second display magnification different from the first display magnification is set, control is performed to perform stereoscopically unviewable display as the display of the processed image.

2. The electronic device according to claim 1, wherein
the program, when executed by the processor, further causes the electronic device to perform acquisition processing of acquiring one image including two image areas having parallax as the image before the image processing is performed, and,
in the control processing, in a case where the first display magnification is set, control is performed to perform the stereoscopically viewable display using both of the two image areas, and, in a case where the second display magnification is set, control is performed to perform the stereoscopically unviewable display using one image formed by cutting out one of the two image areas and disposing the one of the two image areas at two positions.

3. The electronic device according to claim 1, wherein
each of the two image areas is a fish-eye image area.

4. The electronic device according to claim 1, wherein
the first display magnification includes a same magnification.

5. The electronic device according to claim 1, wherein, in the control processing, control is performed to perform the stereoscopically viewable display in a case where a same magnification is set, and control is performed to perform the stereoscopically unviewable display in a case where the display magnification that is not the same magnification is set.

6. The electronic device according to claim 1, wherein
the image processing includes equirectangular transformation.

7. The electronic device according to claim 1, wherein
the image processing includes perspective projection transformation.

8. The electronic device according to claim 1, wherein,
in the control processing, in a case where a specific mode is set, control is performed to display the processed image at the first display magnification even if the second display magnification is set.

9. The electronic device according to claim 1, wherein,
in the control processing, in a case where an amount of movement of a range to be displayed is larger than a threshold, control is performed to display the processed image at the first display magnification even if the second display magnification is set.

10. The electronic device according to claim 9, wherein,
in the control processing, control is performed to display the processed image on a head-mounted display device, and
the range to be displayed changes with a change in orientation of the head-mounted display device.

11. A control method of an electronic device, comprising:
setting a display magnification of an image,
performing image processing to reduce distortion of the image, and
performing control to display a processed image at the set display magnification, the processed image being an image after the image processing is performed, wherein,
in a case where a first display magnification is set, control is performed to perform stereoscopically viewable display as display of the processed image, and, in a case where a second display magnification different from the first display magnification is set, control is performed to perform stereoscopically unviewable display as the display of the processed image.

12. A non-transitory computer readable medium that stores a program, wherein the program causes a computer to execute a control method of an electronic device, the control method comprising:
setting a display magnification of an image,
performing image processing to reduce distortion of the image, and
performing control to display a processed image at the set display magnification, the processed image being an image after the image processing is performed, wherein,
in a case where a first display magnification is set, control is performed to perform stereoscopically viewable display as display of the processed image, and, in a case where a second display magnification different from the first display magnification is set, control is performed to perform stereoscopically unviewable display as the display of the processed image.
